(19) United States
(12) Patent Application Publication
(10) Pub. No.: US 2020/0061871 A1
(43) Pub. Date: Feb. 27, 2020

(54) SYSTEMS AND APPARATUS FOR ADDITIVE MANUFACTURING

(71) Applicant: Cincinnati Incorporated, Harrison, OH (US)

(72) Inventors: Daniel Gerade, Chelmsford, MA (US); Alfonso Perez, Orlando, FL (US)

(21) Appl. No.: 16/106,488

(22) Filed: Aug. 21, 2018

(51) Int. Cl. B29C 33/44; B29C 64/245; B29C 64/10

(52) U.S. Cl. CPC B29C 33/442; B33Y 10/00; B29C 64/10; B29C 64/245

(57) ABSTRACT

An additive manufacturing system includes a printing surface for supporting a printed part, and a part removal system, including at least one wire configured to move relative to the printing surface and configured to engage the printed part for removing the printed part from the printing surface. In another embodiment, an additive manufacturing system includes a printing surface for supporting a printed part, and a part removal system, including at least one saw configured to move relative to the printing surface and configured to engage the printed part for removing the printed part from the printing surface.

### FIELD OF THE INVENTION

The present invention relates generally to additive manufacturing systems and methods and, more particularly, to additive manufacturing systems having automated systems for removing the manufactured parts.

### BACKGROUND OF THE INVENTION

The manufacturing systems widely known as 3D printers operate based on a class of manufacturing techniques known as additive manufacturing. Additive manufacturing differs from subtractive processes (e.g., conventional machining, grinding, lapping) and net-shape processes (e.g., casting, bending, spinning) by incrementally depositing material to achieve desired part geometry. The modern additive manufacturing industry subsumes numerous technologies ranging from selective laser sintering (SLS) to layered object manufacturing (LOM). One of the most widely use forms of additive manufacturing technology is fused filament fabrication (FFF) also known as Fused Deposition Modeling (FDM).

FDM or FFF is just one of many 3D printing or additive manufacturing processes. Other processes include, but are not limited to, SLA, SLS, DMLS, WAAM, nano lithography etc.

3D printing, a form of additive manufacturing, is a laborious manufacturing process in its existing state. First, a user designs a 3-D model using CAD software. The user then manually uploads the .stl (or other equivalent 3D model file format) of the desired 3D part to be made. Next the 3D model is processed by a slicing program to create the machine specific code required by the 3D printer in order to produce the desired 3D printed part. The next step in the process is to upload the machine code to the 3D printer or the 3D printer host program, typically achieved in the form of a program on a computer, the 3D printer, a cloud solution, a thumb drive, or an SD card. From there, the machine code is streamed to a microprocessor on the 3D printer. After the 3D printer is done 3D printing the part, the part is removed manually. In most cases the user is required to use a hand tool, such as but not limited to a paint scraper or knife to remove the 3D part from the print surface.

A fully automated 3-D printer system requires automated part removal so as to eliminate the need for a local human operator to remove a part in order to start a next job. In general the disadvantages of current automated part removal systems are detrimental to the printing process and/or the removal process

Thus, it would be desirable to provide an improved automated removal system for additive manufacturing.

### SUMMARY

In one embodiment, an additive manufacturing system includes a printing surface for supporting a printed part, and a part removal system, including at least one wire configured to move relative to the printing surface and configured to engage the printed part for removing the printed part from the printing surface. The at least one wire may be configured to be held in constant tension while moving relative to the printing surface. Alternatively, the at least one wire may be configured to be held in variable tension while moving relative to the printing surface. In one embodiment, the at least one wire is configured to be heated while moving relative to the printing surface. In addition or alternatively, the at least one wire may be configured to be electrified while moving relative to the printing surface. In one embodiment, the at least one wire is configured to rotate while moving relative to the printing surface. In addition or alternatively, the at least one wire may be configured to reciprocate while moving relative to the printing surface. The at least one wire may be permitted to vibrate while moving relative to the printing surface. For example, the at least one wire may be controlled to vibrate while moving relative to the printing surface. In one embodiment, the part removal system further includes at least one linear actuator configured to move the at least one wire relative to the printing surface.

In another embodiment, an additive manufacturing system includes a printing surface for supporting a printed part, and a part removal system, including at least one saw configured to move relative to the printing surface and configured to engage the printed part for removing the printed part from the printing surface. The at least one saw may be configured to be held in constant tension while moving relative to the printing surface. Alternatively, the at least one saw may configured to be held in variable tension while moving relative to the printing surface. In one embodiment, the at least one saw is configured to be heated while moving relative to the printing surface. In addition or alternatively, the at least one saw may be configured to be electrified while moving relative to the printing surface. In one embodiment, the at least one saw is configured to rotate while moving relative to the printing surface. In addition or alternatively, the at least one saw may be configured to reciprocate while moving relative to the printing surface. The at least one saw may be permitted to vibrate while moving relative to the printing surface. For example, the at least one saw may be controlled to vibrate while moving relative to the printing surface. In one embodiment, the part removal system further includes at least one linear actuator configured to move the at least one saw relative to the printing surface.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1 is a top view of a wire based automated part removal system for use in 3D printers, in accordance with an embodiment of the invention.

FIG. 2 is a front view of the wire based automated part removal system of FIG. 1.

FIG. 3 is a front view of an alternative wire based automated part removal system for use in 3D printers.

FIGS. 4A-4D illustrate an automated part removal process, in accordance with an embodiment of the invention.

FIG. 5 is a top view of a saw based automated part removal system for use in 3D printers, in accordance with an embodiment of the invention.

FIG. 6 is a front view of the saw based automated part removal system of FIG. 5.

### DETAILED DESCRIPTION OF THE INVENTION

The automated part removal systems described herein apply to any and all types of 3D printing machines or additive manufacturing machines. The rest of this disclosure will be described in the context of the FDM or FFF process workflow and variable. However, it must be noted that to those skilled in the art each different 3D printing or additive manufacturing process can be automated using automated part removal techniques disclosed herein.

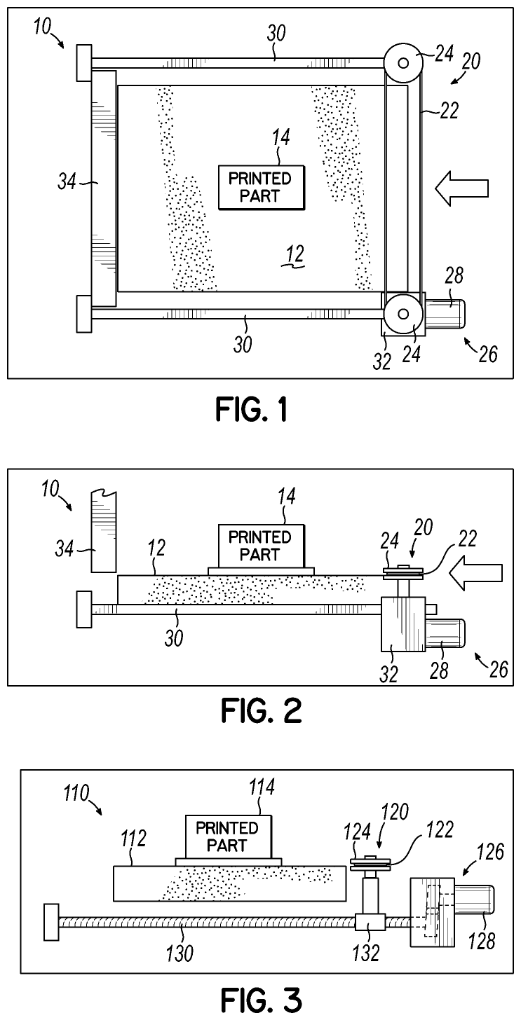

With reference to FIGS. 1 and 2, a three-dimensional printing system 10 according to one embodiment includes a printing surface 12 on which a 3D printed part 14 is made. A printing device such as a print head or laser (not shown) is supported for controlled movement with respect to the printing surface 12 to print the part 14 on the printing surface 12. As shown, the printing system 10 includes an automated part removal system 20, including a wire 22 supported for motion across the printing surface 12 to release the part 14 from the printing surface 12. In one embodiment, the wire 22 may be fixed at both ends thereof and held in tension, such as via one or more pulleys 24. By “fixed,” it is meant that the wire 22 is held at both ends such that the ends do not move apart from one another. For example, the pulleys 24 may be locked against rotation. Alternatively, the pulleys 24 may be replaced with nonrotatable holders (not shown) for holding the ends of the wire 22 in tension. In one embodiment where the wire 22 is fixed at both ends, the wire 22 may be cantilevered from a support on one side of the printing surface 12 for motion across the printing surface 12. Alternatively, the wire 22 that is fixed at both ends may be supported on both sides of the printing surface 12 for motion across the printing surface 12. For a cantilevered wire 22 fixed at both ends, the support may form a compliant joint allowing for leveling of the wire 22 fixed at both ends relative to the printing surface 12. In addition or alternatively, the wire 22 may have a hardened steel portion that engages the part 14. In one embodiment, the wire 22 may have a hardened external surface for engaging the 3D printed part 14 on the print surface 12 and the internal core of the wire 22 may be constructed of a softer alloy to allow for compliance, for example.

As best shown in FIG. 2, at least one of the pulleys 24 may be driven by at least one linear actuator 26 including a motor 28 along at least one corresponding rail 30 to cause the wire 22 to move across the printing surface 12, as indicated by the arrow. In this regard, at least one of the pulleys 24 may be mounted to a carriage 32 configured to traverse the rail 30 via operation of the motor 28. The wire 22 may remain under tension the wire 22 moves across the printing surface 12. As shown, a removal barrier 34 may be positioned downstream of the wire 22 along the rail to prevent the printed part 14 from falling off of the printing surface 12 upon removal by the wire 22.

While one or both pulleys 24 (or nonrotatable holders) may travel along the respective rail(s) 30 in a generally linear direction as shown, it will be appreciated that one or both pulleys 24 may travel in any suitable direction and/or be fixed against movement. For example, one pulley 24 (or nonrotatable holder) may be fixed against movement and the other pulley 24 (or nonrotatable holder) may be driven in an arc or semi-circle across the printing surface 12 while maintaining tension in the wire 22.

With reference to FIG. 3, wherein like numerals represent like features, in one embodiment the linear actuator 126 of the part removal system 120 of an alternative three-dimensional printing system 110 may include a motor 128 operatively coupled to a leadscrew 130 to move the wire 122 fixed at least at both ends to remove the 3D printed part 114 from the 3D printing surface. In this regard, at least one of the pulleys 124 may be mounted to a carriage 132 configured to traverse the leadscrew 130 during rotation of the leadscrew 130 as controlled by operation of the motor 128. Alternatively, a drive pulley driving a belt can be used to move the wire 122. A rack and pinion arrangement may also be employed to move the wire 122. In one embodiment, the wire 122 may be caused to vibrate to assist in removing the part 114. In addition or alternatively, the wire 122 may configured to be heated relative to the 3D printed part 114 and/or relative to the surface 112 on which the 3D printed part 114 is made. The wire 122 may be heated using radiative heating, conductive heating, resistive heating, or convective heating, for example. The wire 122 may also be electrically charged relative to the charge of print surface 112 and/or charge of the 3D part 114.

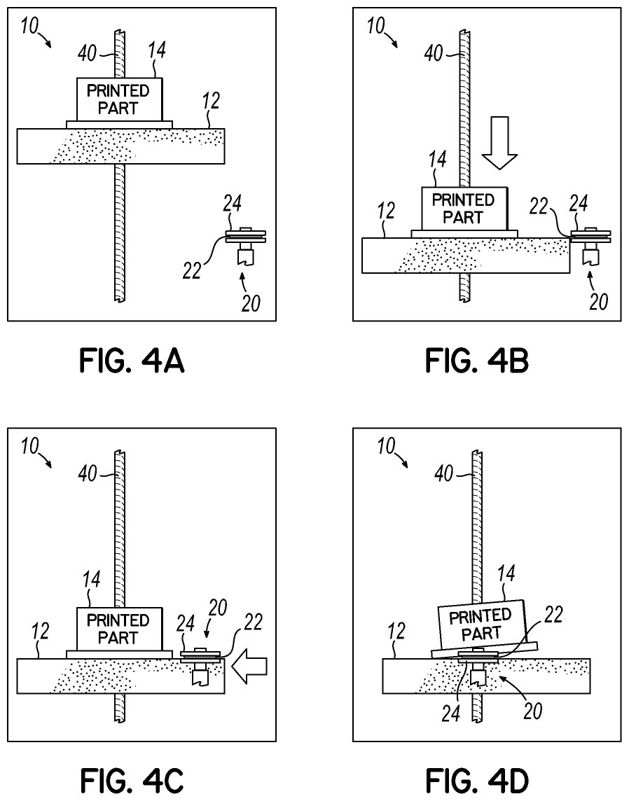

With reference to FIGS. 4A-4D, a sequence of 3D printer commands may be executed by a controller (not shown) to ensure that the automated part removal system 20 is level with the printing surface 12 on which the part 14 is made. For example, in the case of an XYZ or gantry 3D printer, the print surface 12 on which the part 14 is made may initially be positioned vertically above the wire 22 of the automated part removal system 20 during printing of the part 14, as shown in FIG. 4A. The print surface 12 may be configured to automatically lower approximately to the level of, or slightly below, the wire 22 of the automated part removal system 20 after printing of the part 14, such as via a leadscrew or rail 40, as indicated by the arrow in FIG. 4B. The automated part removal system 20 may be configured to subsequently move one or both ends of the wire 22 (e.g., at the respective pulleys 24) parallel to the print surface 12 on which the part 14 is made at least until the wire 22 engages with the print surface 12 and/or the 3D printed part 14, as shown in FIG. 4C. Once the wire 22 has made contact with the print surface 12 or the 3D printed part 14, the wire 22 continues to traverse the print surface 12 on which the part 14 is made to gradually separate the 3D printed part 14 from the 3D printing surface 12 until the 3D printed part 14 is removed from the 3D printing surface 12, as shown in FIG. 4D. In one embodiment, after removing the 3D printed part 14 from the 3D printing surface 12, the printing surface 12 may be lowered, and the wire 22 may be returned to its original position (e.g., as shown in FIGS. 4A and 4B). During such movement of the wire 22, the wire 22 may impact the removed 3D printed part 14 to push the 3D printed part 14 toward or into a part collection bin (not shown).

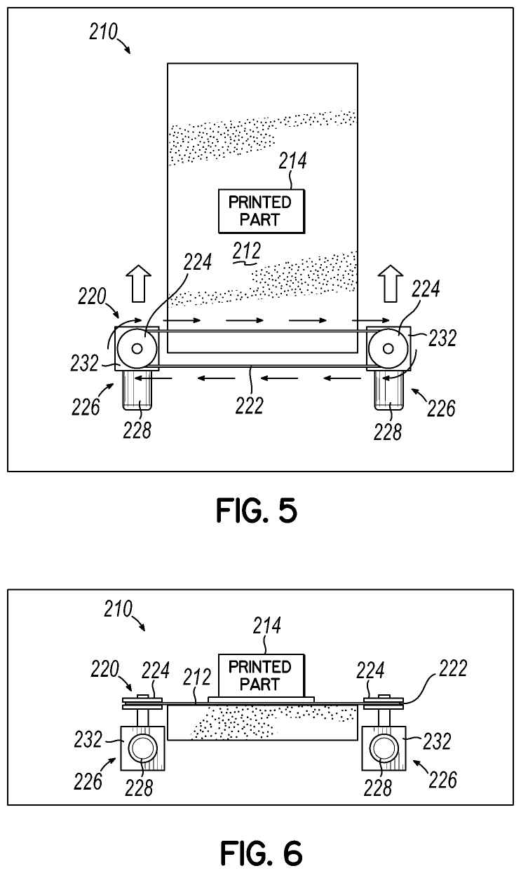

With reference to FIGS. 5 and 6, wherein like numerals represent like features, in another embodiment, the wire 222 of a three-dimensional printing system 210 may be configured to rotate in a manner similar to a rotary saw and/or translate back and forth or reciprocate in a manner similar to a linear saw in a direction generally parallel to the 3D printing surface 212 on which the part 214 is 3D printed, as indicated by the small arrows in FIG. 5. Thus, the wire 222 may be considered a saw. In the embodiment shown, both pulleys 224 are mounted to respective carriages 232 driven by respective linear actuators 226 including motors 228, such that the entire automated part removal system 220 may move across the printing surface 212 as a uniform body. While not shown, one or more leadscrews may be provided to move the wire or saw 222 configured to rotate or translate across the printing surface 212, as indicated by the large arrows in FIG. 5, to remove the 3D printed part 214 from the 3D printing surface 212. Alternatively, a drive pulley driving a belt can be used to move the wire or saw 222 which is configured to rotate or translate across the printing surface 212. A rack and pinion arrangement may also be employed to move the wire or saw 222 which is configured to rotate or translate across the printing surface 212. In one embodiment, the wire or saw 222 which is configured to rotate or translate may be configured to vibrate to assist in removal of the part 214. In addition or alternatively, the wire or saw 222 which is configured to rotate or translate may be configured to be heated relative to the 3D printed part 214 and/or relative to the surface 212 on which the 3D printed part 214 is made. The wire or saw 222 which is configured to rotate or translate may be heated using radiative heating, conductive heating, resistive heating, or convective heating, for example. The wire or saw 222 which is configured to rotate or translate may also be electrically charged relative to the charge of the print surface 212 and/or the charge of the 3D part 214.

As described above, the wire or saw 222 is supported for motion across the printing surface 212 to release the part 214 from the printing surface 212. In one embodiment, the wire or saw 222 may be fixed at both ends and held in tension. In one embodiment where the wire or saw 222 is fixed at both ends, the wire or saw 222 may be cantilevered from a support on one side of the printing surface 212 for motion across the printing surface 212. Alternatively, the wire or saw 222 that is fixed at both ends may be supported on both sides of the printing surface 212 for motion across the printing surface 212, as shown. For a cantilevered wire or saw 222 fixed at both ends, the support may form a compliant joint allowing for leveling of the wire or saw 222 fixed at both ends relative to the printing surface 212. In addition or alternatively, the wire or saw 222 may have a hardened steel portion that engages the part 214. In one embodiment, the wire or saw 222 may have a hardened external surface for engaging the 3D printed part 214 on the print surface 212 and the internal core of the wire or saw 222 may be constructed of a softer alloy to allow for compliance, for example.

In any of the aforementioned embodiments, including those having a fixed, rotating, and/or translating wire or saw 22, 122, 222, the wire or saw 22, 122, 222 may be held under constant or variable tension. In one embodiment, the tensioning device may be configured manually. In another embodiment, the tensioning device may be configured automatically or continuously reconfigured so as to maintain a desired or optimal tensioning of the wire or saw 22, 122, 222 for effectively removing the part 14, 114, 214 from the printing surface 12, 112, 212. For example, variable tensioning of the wire 22 or saw 22, 122, 222 may be provided by winding in or out wire or saw lengths from one of the pulleys 24, 124, 224 or via a tensioning screw or other tensioning mechanism, such as in cases where the length of the wire or saw 22, 122, 222 changes during movement of the wire or saw 22, 122, 222 across the printing surface 12, 112, 212.

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The present invention in its broader aspects is therefore not limited to the specific details and illustrative examples shown and described. Accordingly, departures may be made from such details without departing from the scope of the general inventive concept.

What is claimed is:

1. An additive manufacturing system, comprising:
a printing surface for supporting a printed part; and
a part removal system, comprising at least one wire configured to move relative to the printing surface and configured to engage the printed part for removing the printed part from the printing surface.

2. The additive manufacturing system of claim 1, wherein the at least one wire is configured to be held in constant tension while moving relative to the printing surface.

3. The additive manufacturing system of claim 1, wherein the at least one wire is configured to be held in variable tension while moving relative to the printing surface.

4. The additive manufacturing system of claim 1, wherein the at least one wire is configured to be heated while moving relative to the printing surface.

5. The additive manufacturing system of claim 1, where the at least one wire is configured to be electrified while moving relative to the printing surface.

6. The additive manufacturing system of claim 1, wherein the at least one wire is configured to rotate while moving relative to the printing surface.

7. The additive manufacturing system of claim 1, wherein the at least one wire is configured to reciprocate while moving relative to the printing surface.

8. The additive manufacturing system of claim 1, wherein the at least one wire is permitted to vibrate while moving relative to the printing surface.

9. The additive manufacturing system of claim 8, wherein the at least one wire is controlled to vibrate while moving relative to the printing surface.

10. The additive manufacturing system of claim 1, wherein the part removal system further comprises at least one linear actuator configured to move the at least one wire relative to the printing surface.

11. An additive manufacturing system, comprising:
a printing surface for supporting a printed part; and
a part removal system, comprising at least one saw configured to move relative to the printing surface and configured to engage the printed part for removing the printed part from the printing surface.

12. The additive manufacturing system of claim 11, wherein the at least one saw is configured to be held in constant tension while moving relative to the printing surface.

13. The additive manufacturing system of claim 11, wherein the at least one saw is configured to be held in variable tension while moving relative to the printing surface.

14. The additive manufacturing system of claim 11, wherein the at least one saw is configured to be heated while moving relative to the printing surface.

15. The additive manufacturing system of claim 11, where the at least one saw is configured to be electrified while moving relative to the printing surface.

16. The additive manufacturing system of claim 11, wherein the at least one saw is configured to rotate while moving relative to the printing surface.

17. The additive manufacturing system of claim 11, wherein the at least one saw is configured to reciprocate while moving relative to the printing surface.

18. The additive manufacturing system of claim 11, wherein the at least one saw is permitted to vibrate while moving relative to the printing surface.

19. The additive manufacturing system of claim 18, wherein the at least one saw is controlled to vibrate while moving relative to the printing surface.

20. The additive manufacturing system of claim 11, wherein the part removal system further comprises at least one linear actuator configured to move the at least one saw relative to the printing surface.
